(19) United States
(12) Patent Application Publication
(10) Pub. No.: US 2014/0153391 A1
(43) Pub. Date: Jun. 5, 2014

(54) Method for Policy Control and Method for Bearer Control as Well as Corresponding Servers, Systems and Computer Programs

(71) Applicants: Reiner Ludwig, Hürtgenwald (DE); Susana Fernandez Alonso, Madrid (ES)

(72) Inventors: Reiner Ludwig, Hürtgenwald (DE); Susana Fernandez Alonso, Madrid (ES)

(73) Assignee: TELEFONAKTIEBOLAGET L M ERICSSON (PUBL), Stockholm (SE)

(21) Appl. No.: 14/127,540

(22) PCT Filed: Jun. 22, 2011
(86) PCT No.: PCT/EP2011/060443

§ 371 Date: Feb. 7, 2014

(51) Int. Cl. H04W 28/02; H04W 76/06

(52) U.S. Cl. CPC H04W 28/0252; H04W 76/068
USPC 370/230

(57) ABSTRACT

The present invention relates to a method for policy control carried out by a node including a policy and charging rules function and a method for bearer control carried out by a node including a bearer binding function as well as to a server configured for implementing a policy and charging rules function and a server configured for implementing a bearer binding function, to a system including these servers and functions, and to computer programs comprising instructions configured, when executed on a server, to cause the server to carry out policy control or bearer control. The method for policy control carried out by a node comprises the steps of creating a policy provision including an inactivity period indicator indicating a period allowing a service data flow to be inactive; and providing the policy provision including the inactivity period indicator to be installed in a bearer control element to determine at least one of a bearer establishment, modification and deactivation according to the policy provision including the inactivity period indicator.

### TECHNICAL FIELD

The present invention relates to a method for policy control carried out by a node including a policy and charging rules function and a method for bearer control carried out by a node including a bearer binding function as well as to a server configured for implementing a policy and charging rules function and a server configured for implementing a bearer binding function, to a system including these servers and functions, and to computer programs comprising instructions configured, when executed on a server, to cause the server to carry out policy control or bearer control.

### BACKGROUND

In communication networks, such as telecommunication networks, a call or a service often involves, on the one hand, a control plane or signalling plane and, on the other hand, a user plane or media plane. The control plane or signalling plane is in charge of establishing and managing a connection between two points of the network. The user plane or media plane is in charge of transporting user data or service data.

Network operators have the desire to define and enforce a set of rules in the network. A set of rules constitutes policies. A policy framework for managing and enforcing these policies usually includes at least three elements or functions: a policy repository for storing policy rules, which may be user-specific, a policy decision element or function and a policy enforcement element or function. The purpose of a policy framework includes controlling subscriber access to networks and services as well as the kind of access, i.e. its characteristics.

A policy framework notably addresses the decisions as to whether the subscriber is entitled, or authorized, to enjoy a service, and whether the network can provide the service to the subscriber, and particularly whether the network can provide the service to the subscriber with the desired Quality of Service (QoS).

Policy and charging control architectures, such as, but not limited to, the architecture described in 3GPP TS 23.203 version 11.1.0 (2011-03), Technical Specification Group Services and System Aspects; Policy and charging control architecture (release 11) (available on http://www.3gpp.org/ftp/Specs/2011-03/Rel-11/23_series/), integrate policy and charging control.

One aim of a policy framework is to set up and enforce rules dependent on subscribers and/or desired services to ensure efficient usage of network resources among all subscribers.

An architecture that supports Policy and Charging Control (FCC) functionality is depicted in FIG. 1 which is taken from 3GPP TS 23.203 specifying the PCC functionality for Evolved 3GPP Packet Switched domain including both 3GPP accesses and Non-3GPP accesses. The Policy Control and Charging Rules Function (PCRF) 110 is a functional element that encompasses policy control decision and flow based charging control functionalities. The PCRF provides network control regarding Service Data Flow (SDF) detection, gating, QoS and flow based charging (except credit management) towards the Policy and Charging Enforcement Function (PCEF) 120. The PCRF receives session and media related information from the Application Function (AF) 140 and informs the AF of traffic plane events. The PCRF 110 is also coupled with a subscriber profile repository (SPR) 150.

The PCRF shall provision FCC Rules to the PCEF via the Gx reference point and may provision QoS Rules to the Bearer Binding and Event Reporting Function (BBERF) 130 via the Gxx reference point (for deployments based on PMIP/DSMIP protocol in the core network).

The Gx reference point is defined in 3GPP TS 29.212 “Policy and charging control over Gx reference point”, and lies between the PCRF and the PCEF. The Gx reference point is used for provisioning and removal of FCC rules from the PCRF to the PCEF and the transmission of traffic plane events from the PCEF to the PCRF. The Gx reference point can be used for charging control, policy control or both.

The Rx reference point is defined in 3GPP TS 29.214 “Policy and charging control over Rx reference point” and is used to exchange application level session information between the PCRF and the AF. An example of PCRF is the Ericsson Service-Aware Policy Controller (SAPC), see for example F. Castro et al., “SAPC: Ericsson's Convergent Policy Controller”, Ericsson review No, 1, 2010, pp. 4-9. An example of an AF is the IP Multi-Media Subsystem (IMS) Proxy Call Session Control Function (P-CSCF).

Both Gx and Rx reference points may be based on Diameter, see for example P. Calhoun et al., “RFC 3588: Diameter Based Protocol”, IETF, September 2003.

In the architecture 100 of FIG. 1, the PCRF informs the PCEF through the use of FCC rules on the treatment of each service data flow that is under FCC control, in accordance with the PCRF policy decision(s).

The node including the PCEF or another Bearer Binding Function encompasses SDF detection based on filter definitions included in the PCC rules, as well as online and offline charging interactions (not described here) and policy enforcement. Since the PCEF is usually the one handling bearers, it is where the QoS is being enforced for the bearer according to the QoS information coming from the PCRF. This functional entity, i.e. the PCEF, is located at the Gateway, e.g. in the Gateway GPRS Support Node (GGSN), in the GPRS case, For all the cases where there is Proxy Mobile IP (PMIP) or Dual-Stack Mobile IP (DSMIP) in the core network, the bearer control is performed in the BBERF instead.

The Application Function (AF) 140 is an element offering applications in which service is delivered in a different layer, e.g. transport layer, from the one the service has been requested, e.g. signalling layer. The control of resources, such as, but not limited to, IP bearer resources, is performed according to what has been negotiated. One example of a network node including an AF 140 is the P-CSCF (Proxy-Call Session Control Function) of the IP Multi-Media (IM) Core Network (CN) subsystem. The AF 140 may communicate with the PCRF 110 to transfer dynamic session information, i.e. description of multi-media to be delivered in the transport layer. This communication is performed using the above-described Rx interface or Rx reference point, which is placed between the PCRF 110 and the AF 140 and is used to exchange application level information between the PCRF 110 and the AF 140. Information in the Rx interface may be derived from the session information in the P-CSCF and it mainly includes what is called media components. A media component is composed by a set of IP flows, each one described through a 5-tuple, the media type and bandwidth required, for example. Another example of a network node including an AF 140 is a streaming server, which is further exemplary discussed in this specification.

Upon reception of the PCC/QoS rules from the PCRF, a Bearer Binding Function (BBF), either the PCEF or the BBERF depending on the deployment scenario, performs the bearer binding, i.e. associates the provided rule to an IP-CAN bearer within an IP-CAN (Internet Protocol Connectivity Access Network) session. The BBF will use the QoS parameters provided by the PCRF to create the bearer binding for the rule. The binding is created between service data flow(s) included in the PCC/QoS rule and the IP-CAN bearer which have the same QoS Class Identifier (QCI) and Allocation Retention Priority (ARP).

The BBF will then evaluate whether it is possible to use one of the existing IP-CAN bearers or not. If none of the existing bearers can be used, the BBF should initiate the establishment of a suitable IP-CAN bearer. Otherwise, if required, e.g. QoS information has changed, the BBF will initiate the modification of the corresponding bearer. For GBR bearers, i.e. bearers with guaranteed bit rate, the BBF will reserve the required resources based on the QoS information provided by the PCRF.

Next, PCC support to applications is described. When an application requires dynamic policy and/or charging control over the IP-CAN user plane to start a service session, the AF will communicate with the PCRF to transfer the dynamic session information required for the PCRF to take the appropriate actions on the IP-CAN network. The PCRF will authorize the session information, create the corresponding PCC/QoS rules and install them in the PCEF/BBERF. The PCEF/BBERF will encompass SDF detection, policy enforcement (gate and QoS enforcement) and flow based charging functionalities. As described in the previous clause, the applicable bearer will be initiated/modified and if required, resources will be reserved for that application.

Once the application or the user equipment (UE) decides to terminate that service, the AF will communicate the PCRF so that the PCRF can remove the applicable PCC/QoS rule(s) and the PCEF/BBERF stops the corresponding SDF detection, policy enforcement and flow based charging functionalities, terminating or updating the applicable bearer, and releasing the corresponding resources.

An application server including the AF, such as a streaming server, may request establishment of a bearer from the PCRF according to its requirements, i.e. video or other streaming services require specific bandwidths, QoS, charging, etc. The AF may set a timer to request to disconnect the bearer after a certain time period but the request may not be understood by the PCRF or may be understood but out of the network operator's control or may take too long.

Since resources are limited in the network and optimized use of them is a requirement for the network operator, resources, and in particularly bearer resources, have to be controlled efficiently. Besides, according to license agreements, operators may be charged by the number of simultaneously established bearers and thus it has to be ensured that they are kept only when required.

On the other hand, the use of services is also controlled at the application layer, as indicated above. The reason why an application decides to terminate a session, however, may depend on the application itself. Apart from the normal termination procedures initiated by the parties involved in the application session, the application operator may terminate the session based on administrative reasons, subscription changes, service expiration or user inactivity at application level.

The application layer and the network may be owned by different entities and thus, the decisions made in the application layer may be unknown to the network operator. As owner of resources, the network operator should still be able to decide when resources are to be released. The decision to release resources may be different depending on users and services, and based on resource demands for a particular service, the kind of service itself or the user category, the operator may decide to release the resources.

It is thus desirable to provide methods, nodes, systems and computer programs to improve efficient usage of bearer resources, and particularly to support the decision of how or when to change bearer resources.

### SUMMARY

Such methods, servers, systems and computer programs are defined in the independent claims. Advantageous embodiments are defined in the dependent claims.

In one embodiment, a method for policy control is provided, which is carried out by a node including a policy and charging rules function. The method comprises creating a policy provision including an inactivity period indicator indicating a period allowing a service data flow to be inactive, and providing the policy provision including the inactivity period indicator to be installed in a bearer control element to determine at least one of a bearer establishment, modification and deactivation according to the policy provision including the inactivity period indicator. Accordingly, the use of resources in a network can be optimized.

In one embodiment, a method for bearer control is provided, which is carried out by a node including a bearer binding function. The method comprises receiving from a policy control element a policy provision including an inactivity period indicator indicating a period allowing a service data flow to be inactive. Further, the method comprises monitoring service data associated with the service and determining whether to modify or deactivate a bearer according to the inactivity period indicator and the monitored service data. Accordingly, the use of resources in a network can be optimized.

In one embodiment, a node is provided which is configured for implementing a policy and charging rules function. The node comprises a provision creator which is configured to create a policy provision including an inactivity period indicator indicating a period allowing a service data flow to be inactive. The node further comprises a provision provider configured to provide the policy provision including the inactivity period indicator to be installed in a bearer control element to determine at least one of a bearer establishment, modification and deactivation according to the policy provision including the inactivity period indicator. Accordingly, use of resources, such as bearers, in a network can be optimized.

In one embodiment, a node is provided which is configured for implementing a bearer binding function (BBF). The node comprises a provision obtainer which is configured to receive a policy provision including an inactivity period indicator indicating a period allowing a service to be inactive. The node further comprises a monitor configured to monitor service data associated with the service, and an inactivity determiner configured to determine whether to modify or deactivate a bearer according to the inactivity period indicator and the monitored service data. Accordingly, the use of resources, such as bearers, in a network can be optimized.

In another embodiment, a system for bearer control is provided. The system comprises a provision creator configured to create a policy provision including an inactivity period indicator indicating a period allowing a service to be inactive, and a provision obtainer configured to receive the created policy provision including the inactivity period indicator. Further, the system comprises a monitor configured to monitor service data associated with the service, and an inactivity determiner configured to determine whether to modify or deactivate a bearer according to the inactivity period indicator and the monitored service data. Accordingly, the use of resources, such as bearers, can be optimized in a network.

In another embodiment, a computer program is provided which includes instructions configured, when executed on a data processor, to cause the data processor to execute one of the above-described methods.

Further, advantageous embodiments of the invention are disclosed in the dependent claims.

### BRIEF DESCRIPTION OF THE DRAWINGS

FIG. 1 illustrates an exemplary PCC architecture to assist the reader in understanding an exemplary context, in which embodiments of the invention may be applied.

FIG. 2 illustrates operations of a method for policy control according to an embodiment.

FIG. 3a illustrates operations of a method for bearer control according to an embodiment.

FIG. 3b illustrates operations of a method for bearer control in more detail.

FIG. 4 illustrates elements of a node configured to implement a policy and charging rules function according to an embodiment.

FIG. 5 illustrates elements of a node configured to implement a bearer binding function according to one embodiment.

FIG. 6 illustrates elements of a system for policy and bearer control according to an embodiment.

FIG. 7 illustrates an exemplary method according to an embodiment, showing inactivity supervision at the PCC rule level.

FIG. 8 illustrates an exemplary method according to an embodiment, showing inactivity supervision at an IP-CAN session level.

FIG. 9 illustrates an example showing a service data flow between a server and a client.

### DESCRIPTION OF THE EMBODIMENTS

The further embodiments of the invention are described with reference to the Figures. It is noted that the following description contains examples only and should not be construed as limiting the invention.

In the following, similar or same reference signs indicate similar or same elements or operations.

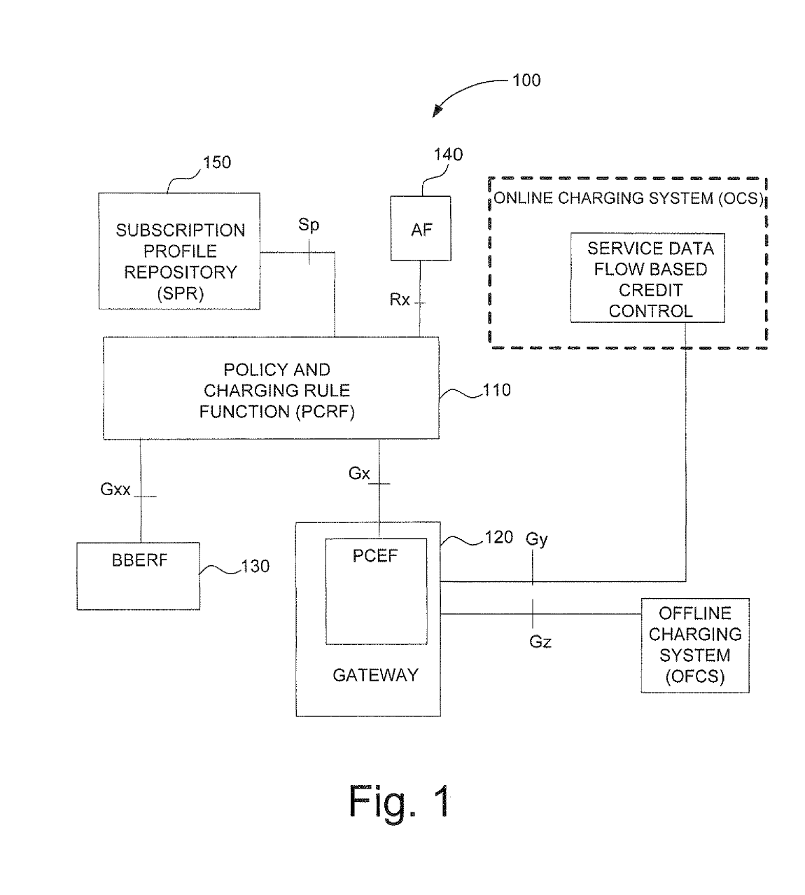

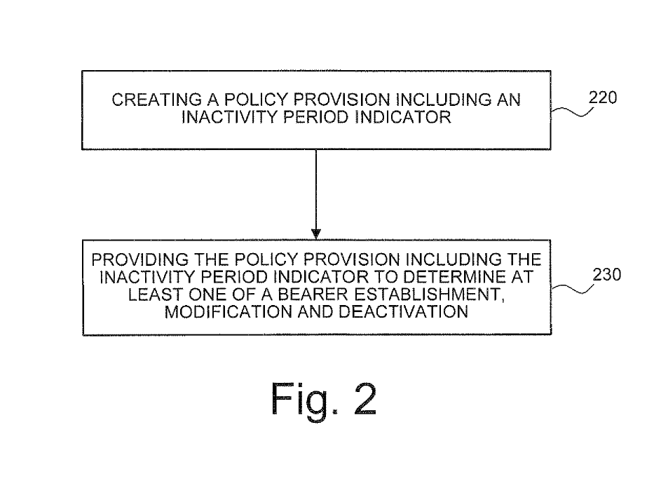

FIG. 2 illustrates a flow chart of a method for policy control which is carried out by a node including a Policy and Charging Rules Function (PCRF), such as node 110 in FIG. 1. As will be described further below, this node may be a server including or implementing the PCRF which is a functional element.

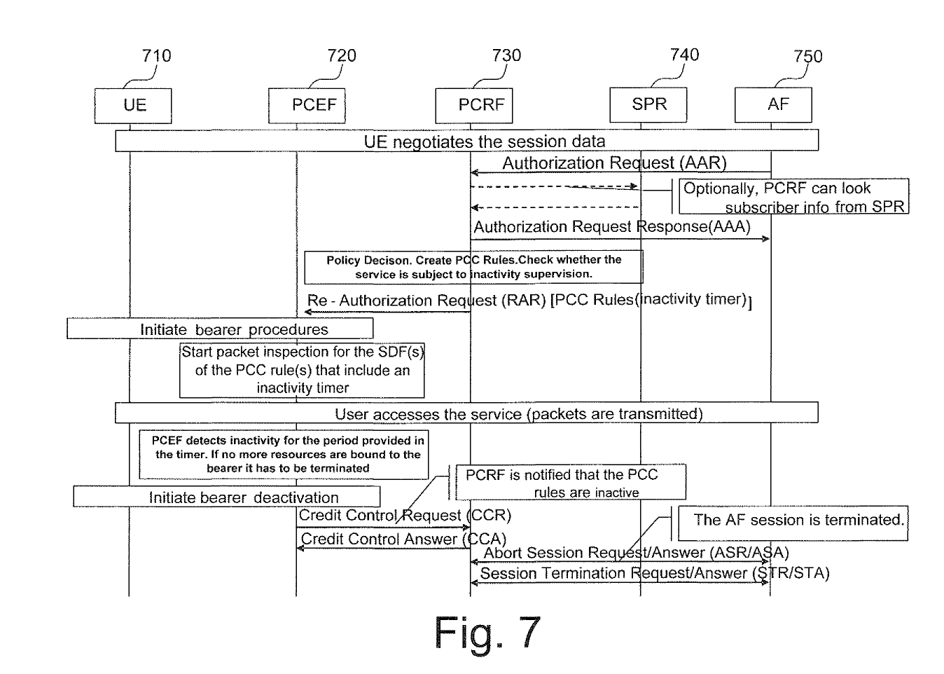

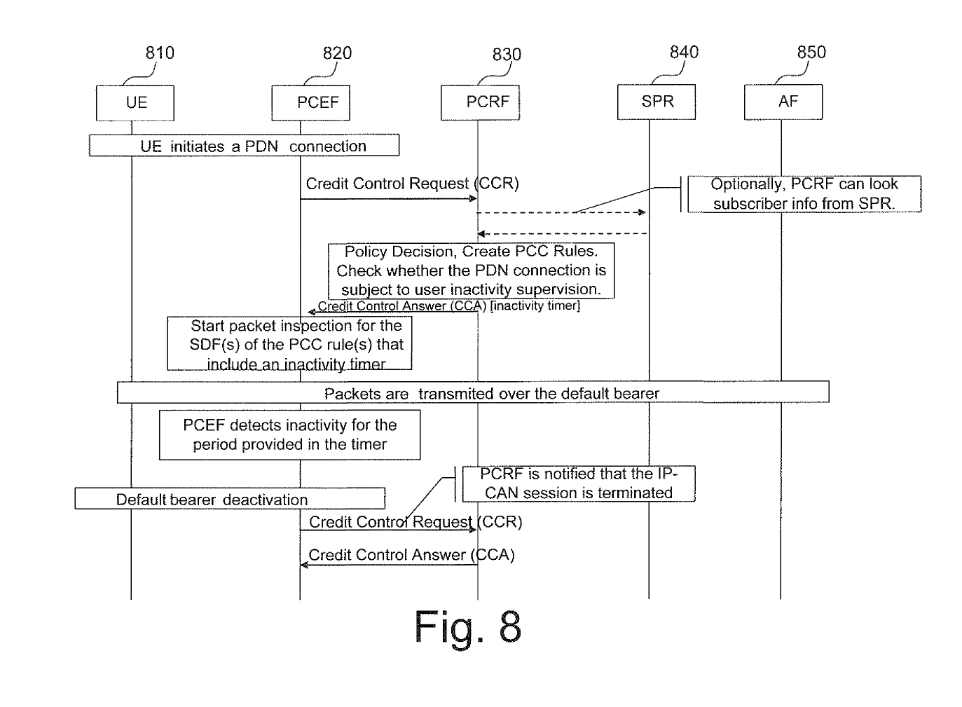

According to the method shown in FIG. 2, in step 220, a policy provision including an inactivity period indicator is created. For example, the policy provision is a policy rule, such as a PCC rule, or a message, e.g. a Diameter command of the Diameter protocol of an IP-CAN session, wherein specific examples will be described below with respect to FIGS. 7 and 8. A policy provision may be created and provided to a node to support bearer binding and to enforce the policy by that node. For example, one or more PCC rules may be linked to an IP-CAN session.

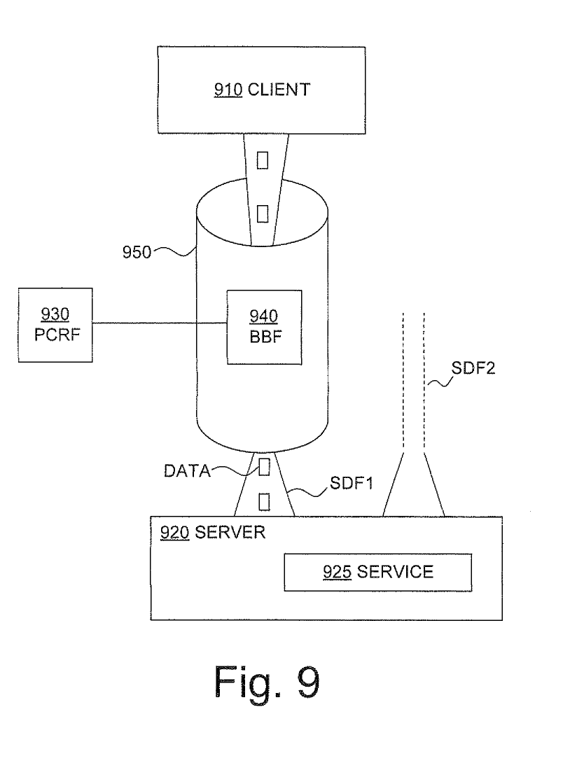

The inactivity period indicator indicates a period allowing a Service Data Flow (SDF) to be inactive. For example, the inactivity period indicator is realized by a timer, and the policy provision, e.g. the PCC rule or the message above, includes this timer. As will be described in more detail with respect to the example presented in FIG. 9, during the inactivity period, a service data flow between a service of an application server and a client requesting the service is allowed to be inactive, i.e. no service data is transferred in the SDF for the user operating the client. The inactivity period may be a time period that is restarted each time traffic is detected or alternatively it may work cumulatively, namely inactivity periods may be added and if the sum is exceeded, the bearer is deactivated so that the least used service a user is connected to can be disconnected.

The creation of the policy provision may be performed after negotiation between the client, e.g. user equipment (UE), and the application server including the AF, which may lead to the establishment of a negotiated session. For example, node 110 of FIG. 1 receives service session information from a node, such as node 140, for creating the policy provision. Service session information may comprise a description of the media to be delivered in the transport layer from the AF to a client which requested data on the signalling layer. However, the creation of a policy provision may alternatively or additionally be based on local policies (operator polices), e.g., defined in the PCRF.

In step 230, the policy provision including the inactivity period indicator is provided to be installed in a bearer control element, such as a node including a BBF, PCEF or BBERF, to determine at least one of a bearer establishment, modification and deactivation according to the policy provision including the inactivity period indicator. In particular, the bearer establishment or modification comprises associating the provided policy provision related to a service data flow to the bearer selected to transport the service data within a service session. It is noted that although the BBF is described with respect to the PCEF and BBERF, there are cases where the BBF can be in the PCRF, see for example TS 23.203 Section 6.1.1.4.

Next, the bearer binding process, which includes creating, modifying and deleting bindings, is explained by referring to the exemplary PCC architecture of FIG. 1. Upon reception of the policy provision, e.g. a PCC/QoS rule, from node 110, a Bearer Binding Function (BBF), either the PCEF in node 120 or the BBERF in node 130, performs the bearer binding, i.e. associates the provided rule to an IP-CAN bearer within an IP-CAN session. The IP-CAN bearer which supports SDFs by transporting service data may be considered an IP transmission path of defined capacity, delay and bit error rate, and is defined in 3GPP TS 21.905.

According to the above, the policy provision, e.g. PCC rule, includes the inactivity period indicator indicating the BBF that upon a period of inactivity, the BBF is to initiate bearer disconnection or modification. That is, whenever a PCC rule is established, the PCRF may provide an inactivity timer that indicates the inactivity period allowed for an SAF before initiating the release or modification of the related bearer resources. The BBF uses the policy provision provided by the PCRF to create the bearer binding. In detail, the binding is created between SDF(s) included in the PCC/QoS rule(s) and the IP-CAN bearer which has the same QoS Class Identifier (QCI) and/or Allocation Retention Priority (ARP).

For example, the BBF initiates the bearer disconnection when all the PCC/QoS rules bound to that bearer are deactivated, i.e. the corresponding inactivity period(s) set by one or more timers have expired without any monitored service data of SDFs. However, the PCRF may modify the timers at any moment during the lifetime of the IP-CAN session.

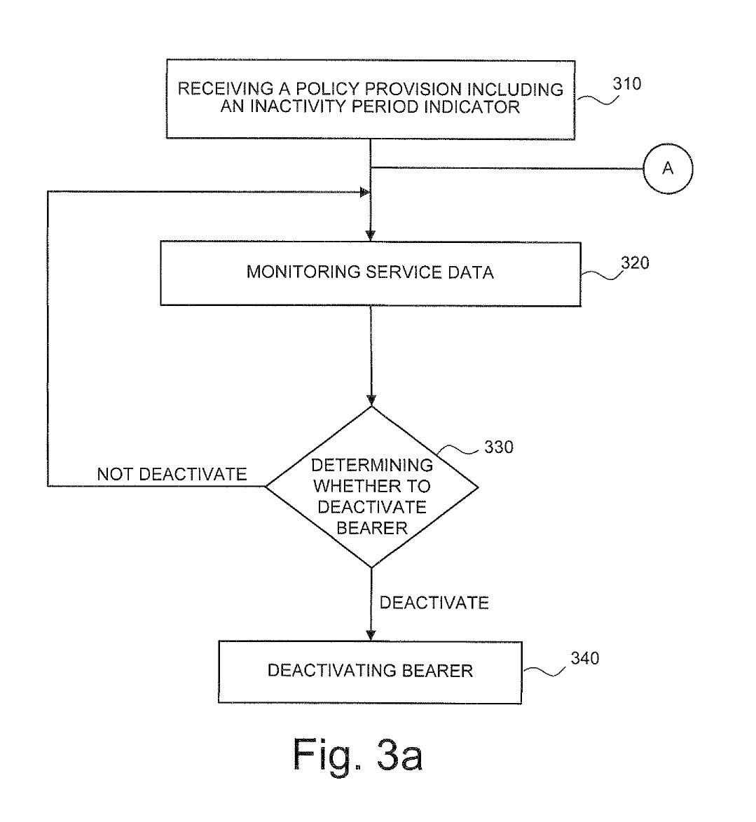

In the following, the operations carried out by a node, e.g. a router, including the BBF, such as node 120 or node 130 of FIG. 1 is explained with respect to FIG. 3a.

In step 310, the above-described policy provision including an inactivity period indicator is received from a policy control element, such as the node 110 including the policy and charging rules function. As discussed above, the inactivity period indicator indicates a period allowing a service data flow to be inactive. The SDF is the aggregation of packets belonging to one service according to 3GPP TS 23.203. The SDF may be regarded as a bitpipe which is present even when inactive. When the SDF is inactive, no data, e.g. data packets, goes through the bitpipe. For example, the data is service data associated with the service and there may be different PCC rules for one or more services provided by an application server, such as server 920 of FIG. 9.

In step 320, the service data of the SDF, which is associated with the service, is monitored. Monitoring may be performed based on filter definitions in the PCC rules or QoS rules. For example, once the policy provision, e.g. PCC rule, is received, a binding is created between the SDF included in the PCC rule and a bearer. Hereby, the BBF either establishes a new bearer or modifies an existing bearer for the received PCC rule so that the BBF is configured to change the bearer binding based on the monitored service data.

In step 330, it is determined whether to modify or deactivate the bearer according to the inactivity period indicator and the monitored service data. For example, when no service data is monitored for a long time, and there is no other SDF bound to the bearer, the bearer may be deactivated, as indicated in step 340. If there is another SDF bound to the bearer which is active, the bearer may be modified to only accommodate the other SDF. This is described in the following in more detail with respect to FIG. 3b.

Similar to the method in FIG. 3a, service data associated with the service is monitored in step 320 in FIG. 3b after the policy provision is received.

Step 330′ further explains an example of the determination of step 330. In detail, the determining step 330′ comprises comparing the inactivity period indicated by the inactivity period indicator with a time period in which no service data, i.e. traffic, has been detected.

The inactivity period indicator may be provided to the PCEF by an inactivity timer which may be part of the policy provision. This inactivity timer may set the inactivity period, for example once the binding between the SOF and the bearer is created, to 100 seconds. Accordingly, the service data is monitored and if after a time period of 100 seconds or longer, it is determined that no service data is detected, the process in FIG. 3b advances to step 340, according to which the bearer is deactivated. In other words, the inactivity period indicator indicates an inactivity period, such as 100 seconds, which is allowable for the service before resources bound to the bearer are released. Such a resource may be an SDF, and if only one SDF is bound to the bearer, the whole bearer can be deactivated since no more resources are bound to it. Otherwise, the bearer may be modified, and it can be waited until other resources bound to the bearer are released to deactivate the bearer.

The monitoring of service data may be performed by the node including the bearer binding function and the supervision of the inactivity may be controlled based on operator policies or service session information received by the PCRF, wherein the PCRF creates the policy provision accordingly.

Further, the above methods described with respect to FIGS. 2 and 3 may be carried out one after the other by a node including a policy and charging rules function (PCRF) and a node including a bearer binding function, wherein the bearer control element constitutes a function in the node including the bearer binding function (BBF) and the policy control element constitutes a function in the node including the policy and charging rules function.

As an alternative to deactivate a bearer completely, it is also feasible to modify the QoS, e.g. to lower the QoS, assigned to the bearer based on the inactivity timer. This may enable the user to go ahead and use the service even after the inactivity period expired, however, lower QoS is then experienced by the user. The information about the lowered QoS may be provided together with the inactivity period indicator at the node including the BBF, such as node 120, on establishment of the bearer or later by an additional command. For example, the PCRF may be informed of monitored service data and react thereon by sending a command for an already established bearer to be deactivated or to be modified if no or only little traffic is present within a certain time period. Specifically for pipes with guaranteed bit rate this might free space in the connection and unused or not often used services may temporarily be assigned lower rates. After traffic is reported again to the PCRF, the PCRF may command again for higher bit rates.

As an alternative example to step 330′ of FIG. 3b, different to the example discussed in which no service data is detected in the time period, a different determining step may comprise comparing the inactivity period indicated by the inactivity period indicator with a time period in which the amount of service data detected should be below a predetermined threshold. This may be particularly advantageous if a service uses an “are you still there” signalling which provides little but detectable data traffic. In such a case, the logical connection may be regarded as inactive but the traffic is not totally zero. When service data is received, inactivity may be defined as below a minimum traffic level in bits per seconds. This minimum traffic level can be used as a floating average window. Accordingly, it may be decided that if the average data flow over the inactivity period indicated by the timer is less than a minimum threshold, the connection is to be deactivated.

Therefore, if a time period equal to the inactivity period, during which no service data or service data below a minimum threshold is monitored, a bearer is modified or deactivated. The fact that the bearer is modified or deactivated if the time period is equal or longer than the inactivity period, may be informed to the policy control element, such as the PCRF, afterwards.

Since user inactivity in the user plane is one important reason for the operator to decide to release resources, such as SDFs or bearers, that are not being used, the above methods provide the operator with a tool to optimize the resources in their network. Although the decision may be different depending on users and services, the operator may decided using the above-described policy provision including the inactivity period indicator to release the resources after the inactivity period or not based on resource demands for a particular service, the kind of service or the user category. Furthermore, the policy provision can also take into account that inactivity periods may differ depending on the kind of service with a low-priority service having a short inactivity period and high-priority service having a long inactivity period.

Accordingly, the node including the PCRF cannot only release the resources at any time based on operator policies, e.g. subscription removal, but may also release the resources based on user inactivity.

Returning to FIG. 1, in one example, the PCRF 110 creates PCC rules including timers based on information received from the Rx interface. The PCRF 110, depending on the user and the requested service, includes charging and policy information along with a set of IP filter information: each IP 5-tuple is composed of source and destination IP address and ports, and the protocol ID above IP (TCP/UDP). The filters included in PCC rules may define service data flows (SDF), i.e. data flows that are treated in the same way regarding policy and charging. These SDFs are installed in PCEF 120 through the Gx interface as illustrated in FIG. 1.

In one example, a client, such as the client 910 of FIG. 9, may request a service 925, such as a streaming video, from a streaming server 920. The request of the client 910 is received by the PCRF 930 and forwarded to the streaming server 920. The client negotiates the session data and the PCRF creates a policy provision, such as a PCC rule, which is then provided to the BBF 940. To be able for the PCRF to control these extensions, an Attribute Value Pair (AVP) may be used having additional fields for the functions related to the inactivity period indicator.

The BBF 940 establishes a bearer 950 and creates a binding between the service data flow SDF1 and the bearer 950. The node including the BBF 940 may then monitor the service data of the streaming video associated with SDF1. As indicated in FIG. 9, in addition to SDF1 between the server 920 and the client 910, the server 920 may provide another SDF, SDF2, to a different client (not shown). Accordingly, the service may run for multiple clients, all receiving service data through a different SDF or bearer, where the SDF or bearer is subject to policy and charging control which might be different for the different users. In the example of FIG. 9, SDF1 and the associated bearer 950 may be deactivated once service data is not detected anymore for a certain time period, but the same streaming video service may still be provided to a different client through SDF2, the channel of which is still active. Therefore, in case of exceeding the maximum allowed inactivity period, the SDF or bearer between server 920 and client 910 is closed and the client and the service are disconnected.

For example, when a UE requests streaming of a video with a length of 5 min, a binding between the SOF included in a FCC rule and a bearer is created. However, previously there might have been problems with the bearer deactivation, namely the bearer was still bound to an SOF after 5 or more minutes even so no service data was transmitted. This problem may have been caused by several ways, which have been described above, such as the application server did not provide a termination request, the termination request was not understood by the PCRF, e.g. PCRF was temporarily down, or the termination request was scheduled for a time much longer than 5 min. According to the above, by including an inactivity period indicator in the policy provision, the network operator itself is able to flexibly terminate the service session and free resources.

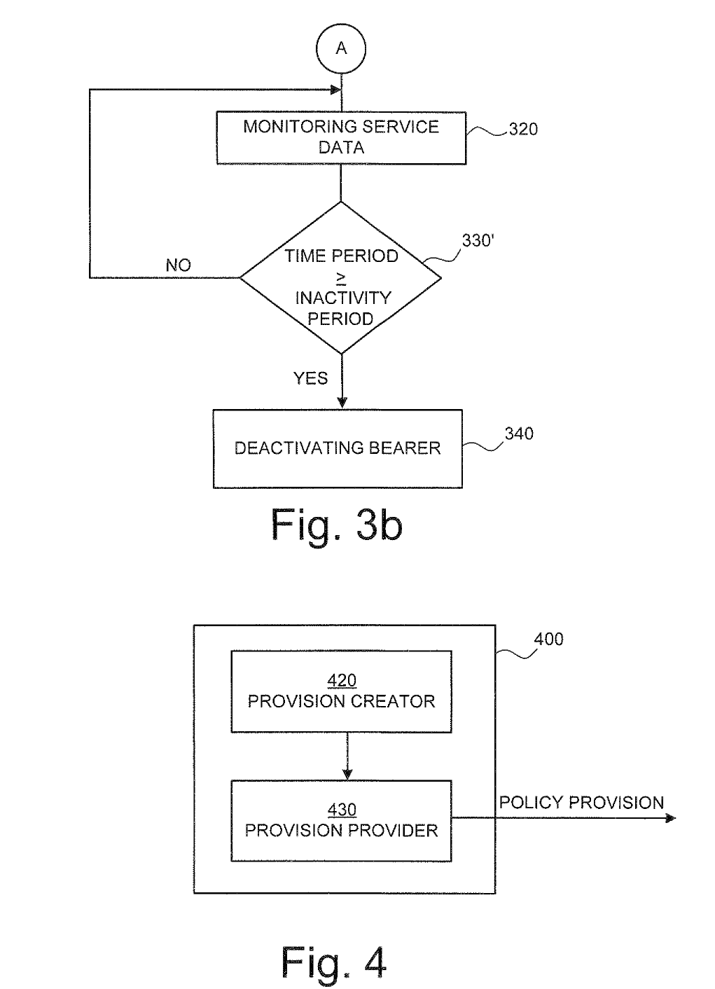

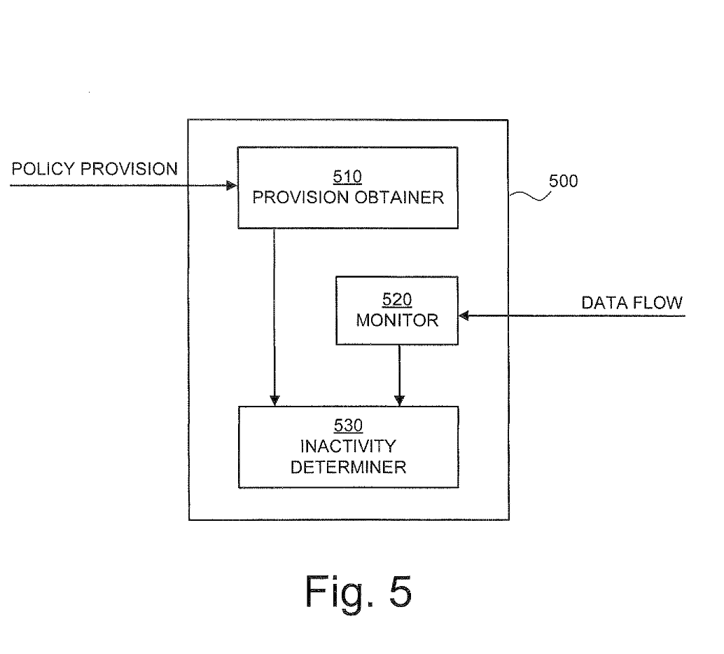

In the following, network nodes specifically adapted to carry out the above-described operations are discussed with respect to FIGS. 4 and 5.

FIG. 4 illustrates elements of a node 400 configured to implement a PCRF according to an embodiment. As mentioned above, the node 400 may be a server comprising a processor to carry out at least some of the above-described functions. In the same way, the server may comprise a provision creator 420 and a provision provider 430 which may be tangible elements instead of software functions.

The provision creator 420 is configured to create a policy provision including an inactivity period indicator indicating a period allowing a service data flow to be inactive. Similar to the above discussion, the policy provision may be a PCC rule or message of an IP-CAN session.

The provision provider 430 is configured to provide the policy provision including the inactivity period indicator to be installed in a bearer control element, such as a node including the BBF, PCEF or BBERF, to determine at Least one of a bearer establishment, modification and deactivation according to the policy provision including the inactivity period indicator.

The policy provision provided by the provision provider 430 of FIG. 4 can then be received and installed by the node 500 of FIG. 5.

The node 500 of FIG. 5 is configured to implement a bearer binding function (BBF) and may be part of a gateway or a router or a server. Node 500 comprises a provision obtainer 510, a monitor 520 and an inactivity determiner 530.

The provision obtainer 510 is configured to receive, e.g. from node 400, the policy provision including the inactivity period indicator indicating a period allowing a service to be inactive.

The monitor 520 is configured to monitor service data associated with the service. The service may be any kind of service provided by an application function, such as the application function 140 of FIG. 1 and is not limited to the example of streaming video described above. In particular, the monitor may be adapted to detect packets that contain service data.

The inactivity determiner 530 is configured to determine whether to modify or deactivate a bearer according to the inactivity period indicator and the monitored service data. The inactivity determiner may be configured to carry out any of the determining steps mentioned with respect to FIGS. 3a and 3b.

To avoid unnecessary repetition of the functions of FIGS. 2 and 3, it is mentioned that these functions may also be carried out by the elements described with respect to FIGS. 4 and 5 in any suitable way.

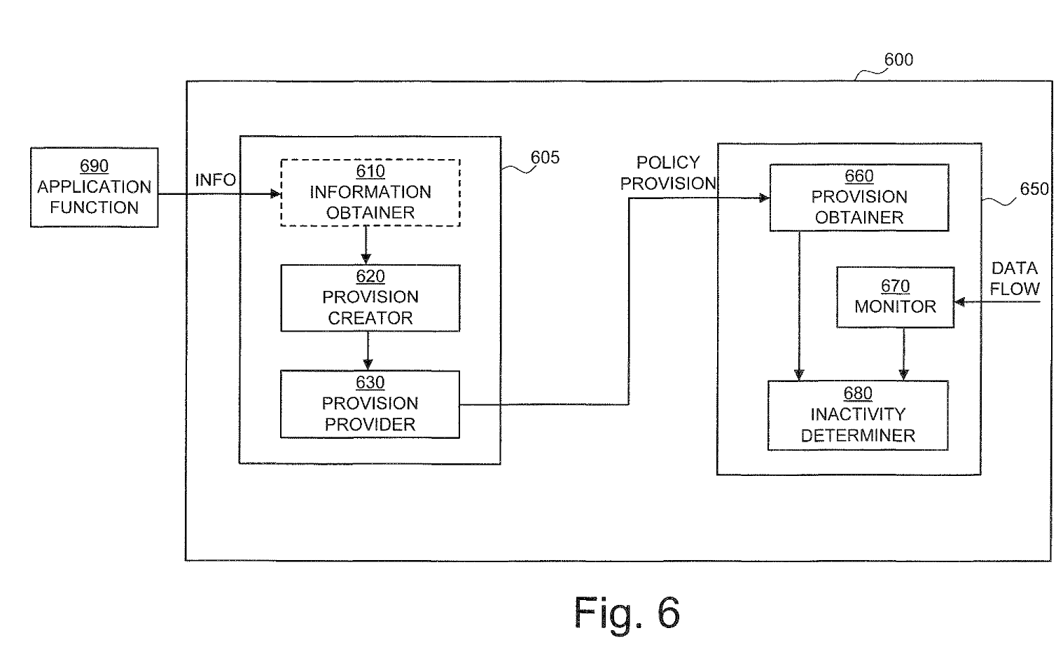

A system basically comprising the node 400 and the node 500 is discussed with respect to FIG. 6. The system 600 of FIG. 6 comprises the node 605 and the node 650.

The node 605 optionally comprises the information obtainer 610 as well as the provision creator 620 and the provision provider 630. The information obtainer 610 is configured to receive service session information from the application function 690. However, as described above, instead of using service session information to create a policy provision, a policy provision may also be created based on operator policies which might be already stored on node 605.

The provision creator 620 has basically the same functions as the provision creator 420 and it is thus referred to the previous discussion to avoid unnecessary repetition. Similarly, the provision provider 630 is basically the same and has the same functions as the provision provider 430.

As can be seen in FIG. 6, the provision provider 630 provides a policy provision, such as a PCC rule, to the node 650, and in particular to the provision obtainer 660.

Node 650 comprises the provision obtainer 660, the monitor 670 and the inactivity determiner 680. The provision obtainer 660, the monitor 670 and the inactivity determiner 680 are basically configured in the same way as the provision obtainer 510, the monitor 520 and the inactivity determiner 530, respectively.

Using the inactivity period indicator included in the policy provision and the result of the monitor 670 monitoring service data as described with respect to monitor 520, the inactivity determiner 680 determines whether to modify or deactivate a bearer according to the inactivity period indicator and the monitored service data.

In the following, exemplary methods showing inactivity supervision at the PCC rule level and inactivity supervision at an IP-CAN session level are discussed with respect to FIGS. 7 and 8, respectively.

The sequences depicted in FIG. 7 are carried out in a system comprising a client, such as a user equipment (UE) 710, a PCEF 720, a PCRF 730, a SPR 740 and an AF 750. The PCEF 720, PCRF 730 and SPR 740 as well as AF 750 may be part of a FCC architecture, such as the one illustrated in FIG. 1. In this example, the BBF is included in the PCEF 720. According to the below described sequence user inactivity related to a service can be controlled.

As seen in FIG. 7, the UE 710 negotiates with the application function 750 the application session conditions. The AF 750 provides the PCRF with service session data for the purpose of authorizing the IP flows, i.e. unidirectional flows of IP packets with the same source IP address and port number and the same destination IP address and port number and the same transport protocol, see Authorization Request (AAR) in FIG. 7. Further, the QoS resources required for the negotiated session are reserved.

Optionally, the PCRF 730 may contact the SFR 740 to obtain subscription data. The SPR 740 may contain information about the subscriber and its policies. If a user is a “premium” subscriber and is permanently able to have bandwidths larger than the average user and/or sessions of this user are connected for a longer time than for the average user (longer inactivity period), this information can be inserted in the SFR 740.

In the next sequence step, the PCRF authorizes the request of the AF 750 by an Authorization Request Response (AAA).

Then the PCRF creates the PCC rule(s) for that service and the PCRF 730 checks if the service requires inactivity supervision and if so, assigns an inactivity timer based on internal policies, for example.

In the next step the PCRF 730 installs the PCC rules in the PCEF 720, wherein the inactivity timer is provided as part of the FCC rule, for example in the Re-Authorization Request (RAR).

The PCEF initiates the bearer procedure so that either a new bearer is initiated or an existing one between the UE 710 and the PCEF 720 is modified.

When an appropriate binding is created between SDF(s) included in the PCC rule(s) and a bearer, the PCEF 720 starts packet supervision for the packets related to the PCC rule(s) that include the inactivity timer. This inspection may be performed while the user accesses the service and packets are being sent.

At a certain point in time, the PCEF may detect an inactivity for the inactivity period provided in the inactivity timer so that resources, such as an SDF may be released. If no more resources, such as SDFs, are bound to the bearer, it has to be terminated. If some resources are still bound, the bearer may be modified. For example, different applications can bind resources to the bearer, and once one application is inactive for a period longer than the inactivity period, this application may be deactivated and the bearer may be modified, e.g. its bandwidths may be changed from 2 Mbits to 1 Mbits.

In other words, when a service related to an application of an application server is not used anymore, the PCEF 720 deletes the PCC rule(s) related to that service and the corresponding resources are released. If no more PCC rules are bound to the applicable bearer, the bearer is deactivated, otherwise it is only modified.

Then, the PCEF may inform the PCRF 730 of the bearer deactivation, i.e. that the PCC rule(s) is inactive. This may be performed in a Credit Control Request (CCR) and the PCRF 730 may respond with a Credit Control Answer (CCA).

In a last sequence step in FIG. 7, the AF 750 is informed and the related session is terminated.

The sequences depicted in FIG. 8 are carried out in a system comprising a client, such as a user equipment (UE) 810, a PCEF 820, a PCRF 830, a SPR 840 and an AF 850. The PCEF 820, PCRF 830 and SPR 840 as well as AF 850 may be part of a PCC architecture, such as the one illustrated in FIG. 1. According to the below described sequence user inactivity related to a service can be controlled. Similar to FIG. 7, the BBF is in the PCEF 820.

First, the UE initiates a PDN (Packed Data Network) connection between the UE 810 and the PCEF 820. Then, the PCEF initiates an IP-CAN session establishment procedure towards the PCRF 830 as indicated by the Credit Control Request (CCR) in FIG. 8. An IP-CAN session may be regarded as an association between a UE and an IP network, which may be identified by one or more UE IPv4 addresses and/or IPv6 prefix together with a UE identity information, if available, and a PDN represented by a PDN ID. An IP-CAN session incorporates one or more IP-CAN bearers.

Optionally, as previously discussed with respect to FIG. 7, the PCRF 830 may obtain subscriber data from the SPR 840. Details of the subscriber data have been described above.

Then the PCRF 830 creates the PCC rules in FIG. 8. The PCRF 830 checks whether the IP-CAN session is subject to user inactivity supervision. This may be achieved by receiving some kind of service session information or looking at internal policies. If inactivity supervision is desired, the PCRF 830 assigns the user inactivity timer, e.g. based on internal policies. The inactivity timer may then be provided in a message, such as a Credit Control Answer (CCA) to the PCEF 820 from the PCRF 830. There is no need to provide the inactivity timer in the PCC rule in this case. In fact the PCC rule could have a different inactivity timer, i.e. the PCEF can monitor that service and at the same time the IP-CAN session. But it can also monitor only the IP-CAN session.

The PCRF 830 provides the PCC rules and QoS information as per normal procedures. The PCRF 830 also provides, as indicated above, the inactivity timer related to the IP-CAN session.

Then, similar to the description of FIG. 7, the PCEF 820 starts packet supervision for the packets transmitted on the default bearer.

At some point in time, the PCEF 820 may detect user inactivity for a period that corresponds or is longer than the inactivity period set by the inactivity timer for that IP-CAN session.

Then the PCEF 820 initiates the PON disconnection procedure and the whole connection including all bearers is deactivated.

Finally, as indicated in FIG. 8 by the Credit Control Request (CCR) and the Credit Control Answer (CCA) the PCRF is informed about the IP-CAN session termination and it deletes the IP-CAN session information and answers back to the PCEF 820. The requests or answers are here messages of the IP-CAN session.

As can be seen in FIGS. 7 and 8 a mechanism for bearer inactivity supervision is introduced that is controlled by the PCRF at both PCC rule level, i.e. at service level, and PDN connection level. During the establishment of the IP-CAN session the PCRF may provide an inactivity timer that indicates the BBF that, upon a period of inactivity controlled by that timer, the BBF shall initiate the default bearer disconnection. In the same way, whenever a PCC/QoS rule is established, the PCRF may provide an inactivity timer that indicates the inactivity period allowed for certain services before initiating the release of related resources. The BBF initiates the termination of the connection when all the PCC/QoS rules bound to the bearer are deactivated. Further, the PCRF may modify the timers at any moment during a lifetime of the IP-CAN session.

According to the above, a network operator can optimize the use of resources in its network. For example, if no service data is detected, it may be determined that a user is not interested anymore in the service so that the bearer related to that service may be deactivated without affecting user's perception. Only if the user changes his/her mind and wants to restart using the service, a bearer has to be re-established.

Further, according to the above, the network operator can optimize the deployed network and can release hanged resources in the network for malfunctioning applications. Additionally, the network operator can adapt the use of the resources in the network to the kind of service and user category provided.

The physical entities according to the different embodiments of the invention, including the elements, nodes and systems may comprise or store computer programs including instructions such that, when the computer programs are executed on the physical entities, steps and operations according to embodiments of the invention are carried out, i.e. cause data processing means to carry out the operations. In particular, embodiments of the invention also relate to computer programs for carrying out the operations according to the embodiments of the invention, and to any computer-readable medium storing the computer programs for carrying out the above-mentioned methods.

Where the terms information obtainer, provision creator, provision provider, provision obtainer, monitor and inactivity determiner are used, no restriction is made regarding how distributed these elements may be and regarding how gathered these elements may be. That is, the constituent elements of the nodes and systems may be distributed in different software or hardware components or other devices for bringing about the intended function. A plurality of distinct elements may also be gathered for providing the intended functionalities.

Further, the elements of the nodes or systems may also be implemented in hardware, software, field-programmable gate arrays (FPGAs), application specific integrated circuits (ASICs), firmware or the like.

It will be apparent to those skilled in the art that various modifications and variations can be made in the entities and methods of this invention as well as in the construction of this invention without departing from the scope or spirit of the invention.

The invention has been described in relation to particular embodiments and examples which are intended in all aspects to be illustrative rather than restrictive. Those skilled in the art will appreciate that many different combinations of hardware, software and/or firmware will be suitable for practicing the present invention.

Moreover, other implementations of the invention will be apparent to those skilled in the art from consideration of the specification and practice of the invention disclosed herein. It is intended that the specification and the examples be considered as exemplary only. To this end, it is to be understood that inventive aspects lie in less than all features of a single foregoing disclosed implementation or configuration. Thus, the true scope and spirit of the invention is indicated by the following claims.

1-17. (canceled)

18. A method for policy control carried out by a node including a policy and charging rules function, the method comprising:
creating a policy provision including an inactivity period indicator indicating a period for which a service data flow is allowed to be inactive; and
providing the policy provision, including the inactivity period indicator, for installation in a bearer control element, to determine at least one of: bearer establishment, bearer modification, and bearer deactivation, in accordance with the policy provision and the included inactivity period indicator.

19. The method of claim 18, further comprising receiving service session information from a node including an application function.

20. The method of claim 19, further comprising, for bearer establishment or modification, associating the provided policy provision with a bearer selected to transport the service data within the service session.

21. A method for bearer control carried out by a node including a bearer binding function, the method comprising:
receiving from a policy control element a policy provision that includes an inactivity period indicator indicating a period for which a service data flow is allowed to be inactive;
monitoring service data associated with the service; and
determining whether to modify or deactivate an associated bearer according to the inactivity period indicator and the monitored service data.

22. The method of claim 21, wherein said determining comprises comparing the inactivity period indicated by the inactivity period indicator with a time period in which the service data flow is detected as inactive.

23. The method of claim 22, further comprising detecting the service data flow as inactive based on comparing the inactivity period indicated by the inactivity period indicator with a time period in which no service data has been detected, or in which the amount of service data detected is below a predetermined threshold.

24. The method of claim 22, further comprising modifying the associated bearer or deactivating the associated bearer, if the time period is equal or longer than the inactivity period.

25. The method of claim 22, further comprising informing the policy control element of the modification or deactivation of the bearer.

26. A method carried out by a node including a policy and charging rules function and a node including a bearer binding function, the method comprising:
creating via a policy control element a policy provision including an inactivity period indicator indicating a period for which a service data flow is allowed to be inactive; and
providing the policy provision, including the inactivity period indicator, for installation in a bearer control element, to determine at least one of: bearer establishment, bearer modification, and bearer deactivation, in accordance with the policy provision and the included inactivity period indicator;
wherein the bearer control element constitutes a function in the node including the bearer binding function and the policy control element constitutes a function in the node including the policy and charging rules function.

27. The method of claim 26, wherein the inactivity period indicator is provided by an inactivity timer which is part of the policy provision.

28. The method of claim 26, wherein the inactivity period indicator indicates an inactivity period allowable for the service before release of resources bound to the bearer, and wherein the bearer is deactivated when no resources are bound to the bearer.

29. The method of claim 26, wherein the policy provision is a policy and charging control rule or a message of an IP-CAN session.

30. The method of claim 16, further comprising controlling inactivity supervision based on operator policies.

31. A node configured for implementing a policy and charging rules function, comprising:
a provision creator configured to create a policy provision including an inactivity period indicator indicating a period for which a service data flow is allowed to be inactive; and
a provision provider configured to provide the policy provision including the inactivity period indicator for installation in a bearer control element, to determine at least one of: bearer establishment, bearer modification and bearer deactivation, in accordance with the policy provision and the included inactivity period indicator.

32. A node configured for implementing a bearer binding function, comprising:
a provision obtainer configured to receive a policy provision including an inactivity period indicator indicating a period for which a service is allowed to be inactive;
a monitor configured to monitor service data associated with the service; and
an inactivity determiner configured to determine whether to modify or deactivate a bearer associated with the service, according to the inactivity period indicator and the monitored service data.

33. A system for bearer control, comprising:
a provision creator configured to create a policy provision including an inactivity period indicator indicating a period for which a service is allowed to be inactive;
a provision obtainer configured to receive the created policy provision, including the inactivity period indicator;
a monitor configured to monitor service data associated with the service; and
an inactivity determiner configured to determine whether to modify or deactivate a bearer associated with the service, according to the inactivity period indicator and the monitored service data.

34. A computer-readable medium storing a computer program comprising program instructions that, when executed on a data processor of a node implementing a policy and charging rules function, configure the policy and charging rules function to:
create a policy provision including an inactivity period indicator indicating a period for which a service data flow is allowed to be inactive; and
providing the policy provision, including the inactivity period indicator, for installation in a bearer control element, to determine at least one of: bearer establishment, bearer modification, and bearer deactivation, in accordance with the policy provision and the included inactivity period indicator.
